(19) United States
(12) Patent Application Publication
(10) Pub. No.: US 2019/0199115 A1
(43) Pub. Date: Jun. 27, 2019

(54) WIRELESS CHARGING SERVICE SYSTEM

(71) Applicants: NEWVASTEK CO., LTD., New Taipei City (TW); GUNITECH CORP., New Taipei City (TW)

(72) Inventors: Ming-Liang Fang, New Taipei City (TW); Chih-Hao Chuang, New Taipei City (TW); Huan-Ruei Shiu, New Taipei City (TW)

(21) Appl. No.: 15/854,757

(22) Filed: Dec. 27, 2017

(51) Int. Cl. H02J 7/02; H02J 50/80; H02J 7/00

(52) U.S. Cl. CPC H02J 7/025; H02J 50/80; H04W 4/008; H02J 2007/0001; H02J 2007/0098; H02J 7/0047

(57) ABSTRACT

The wireless charging service system mainly includes a wireless charging device and a server device. The wireless charging device includes a data transceiver module, a wireless charging module, and a detection module. The server device is data-linked with the data transceiver module of the wireless charging device, and a remote cloud service. A mobile device therefore may interact with the data transceiver module so that info messages prepared by the remote cloud service may be presented on the mobile device. When the mobile device is adjacent to the wireless charging device, the data transceiver module may select different info messages to present on the mobile device. Additional info messages may be added by the remote cloud service.

### BACKGROUND OF THE INVENTION

### (a) Technical Field of the Invention

The present invention generally relates to wireless charging, and more particularly to a system providing wireless charging and information services.

### (b) Description of the Prior Art

The R.O.C. Taiwan Patent No. M525019, titled “Power supplying device and power receiving device of wireless charging system and charge controller thereof,” teaches a power receiving device of a wireless charging system for performing a method of selectively wireless charging. The device includes a processor and a storage unit. The storage unit stores a program which instructs the processor to perform the following steps: searching for a broadcast signal delivered by a power supplying device of the wireless charging system; determining a distance between the power supplying device and the power receiving device according to a strength of the broadcast signal when the broadcast signal is detected; when the distance is smaller than a threshold value, the power receiving device selecting the power supplying device and establishing connection with the power supplying device, and notifying the power supplying device that the power receiving device needs to be charged; and starting to receive power from the power supplying device when the power receiving device is determined to have a charging authorization by the power supplying device. According to the teaching, the power supplying device is able to push information to the power receiving device while the latter is wireless charged. However, a single piece of information is pushed and the information content does not vary, for example, according to the distance between the power supplying and receiving devices, or by remote control in real time. The teaching's applicability is therefore limited.

### SUMMARY OF THE INVENTION

A major objective of the present invention is have a wireless charging device capable of dynamically transmitting different messages to a mobile device entering the coverage of the wireless charging device so as to achieve enhanced real-time information broadcast.

Another major objective of the present invention is to detect the proximity of the mobile device by a Bluetooth control element so that, when the mobile device is adjacent to the wireless charging device, wireless charging to the mobile device is activated. In the meantime, different messages are delivered to the mobile device under charging.

Yet another objective of the present invention is to have a service device data-linked with the wireless charging device so that different messages may be prepared on a remote cloud service and then relayed to the wireless charging device through the server device. As such, the real-time information broadcast may be more flexible and diversified. The wireless charging device may also be remotely activated or deactivated by through the server device.

To achieve the objectives, the wireless charging service system mainly includes a wireless charging device. The wireless charging device includes a data transceiver module, a wireless charging module, and a detection module. The data transceiver module is capable of transmitting one of a number of info messages. The wireless charging module wirelessly charges a mobile device, The Bluetooth control element of the detection module detects whether the mobile device is placed on the wireless charging device and activates/deactivates the wireless charging module. The wireless charging service system further includes a server device data-linked with the data transceiver module of the wireless charging device for sending info messages. The server device is data-linked with a remote cloud service. As such, when the mobile device enters a coverage of the data transceiver module, the mobile device receives an info message and presents the info message on the mobile device's screen. If the mobile device is placed on the wireless charging device for charging, the Bluetooth control element detects the proximity of the mobile device and activates the wireless charging device to start charging. In the meantime, the data transceiver module selects a different info message to transmit. The mobile device therefore may obtain different information based on its activities.

The content of info messages or additional info messages may be edited or created by the remote cloud service. The info messages are relayed to the wireless charging device through the server device.

Even though the prior art may also conduct wireless charging and information broadcast, only a single message may be transmitted and the content of the message cannot be changed when the mobile device is at different distances from the wireless charging device. The message content also cannot be modified remotely, which is quite inconvenient and troublesome. The present invention as described above resolves these issues effectively.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a wireless charging service system according to an embodiment of the present invention.

FIG. 2 is a functional block diagram showing a wireless charging device of the wireless charging service system of FIG. 1.

FIGS. 3 and 4 are perspective diagrams showing a first application scenario of the wireless charging service system of FIGS. 1 and 2.

FIGS. 5 and 6 are perspective diagrams showing a second application scenario of the wireless charging service system of FIGS. 1 and 2.

FIGS. 7 and 8 are perspective diagrams showing a third application scenario of the wireless charging service system of FIGS. 1 and 2.

FIGS. 9 and 10 are perspective diagrams showing a fourth application scenario of the wireless charging service system of FIGS. 1 and 2.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

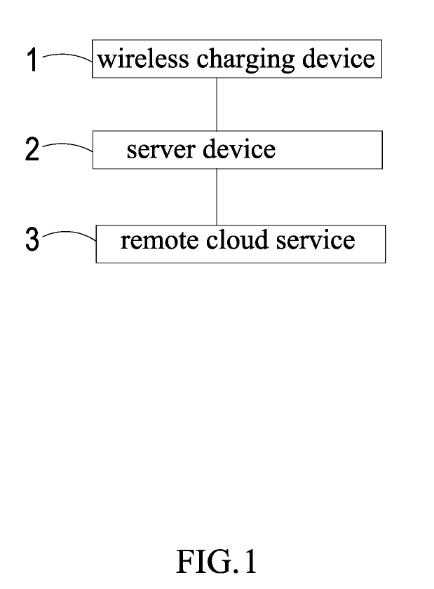

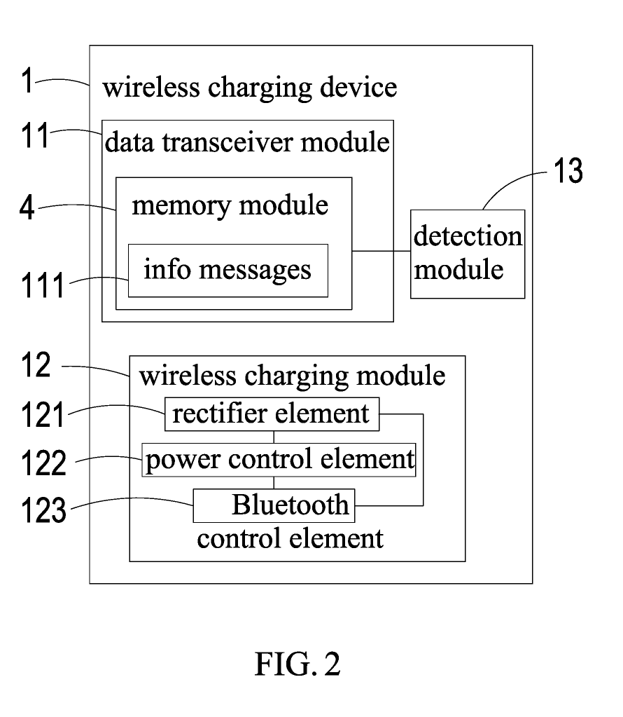

As shown in FIGS. 1 and 2, a wireless charging service system according to the present invention includes the following components.

A wireless charging device 1 includes a data transceiver module 11, a wireless charging module 12, and a detection module 13. The data transceiver module 11 has a micro-location signal transmitter based on Bluetooth (i.e., a beacon) and is capable of transmitting a number of different info messages 111. The wireless charging module 12 has a Power Transfer Unit (PTU) capable of wireless power transfer utilizing technique such as magnetic resonance. The power charging module 12 also operates in accordance with the result of an authentication process with a mobile device. The detection module 13 detects whether the mobile device is placed on the wireless charging device 1 and, depending on the detection result, triggers the data transceiver module 11 to transmit a different info message 111 to the mobile device.

A server device 2 is data-linked with the data transceiver module 11 of the wireless charging device 1, and a remote cloud service 3. The info messages 111 are prepared and edited at the remote cloud service and relayed to wireless charging device 1 through the server device 2's data link with the data transceiver module 11.

A memory module 4 stores at least one of the info messages 111. The remote cloud service 3 may prepare different info messages 111 according to real time events or activities, and store them in the memory module 4.

The wireless charging module 12 includes a rectifier element 121 receiving external power, a power control element 122 electrically connected to the rectifier element 121, and a Bluetooth control element 123 electrically connected to the rectifier and power control elements 121 and 122. The data transceiver module 11 is electrically connected to the power control element 122. The power control element 122 may activate or deactivate the wireless charging device 1 commanded by the remote cloud service 3. The remote cloud service 3 may also collect statistic data from the wireless charging device 1 regarding how many times it has provided charging service, and/or how the mobile device 5 has navigated and selected information form the info messages 111.

The info messages 111 may include information about an APP, a web page, a map, information about stores, or news.

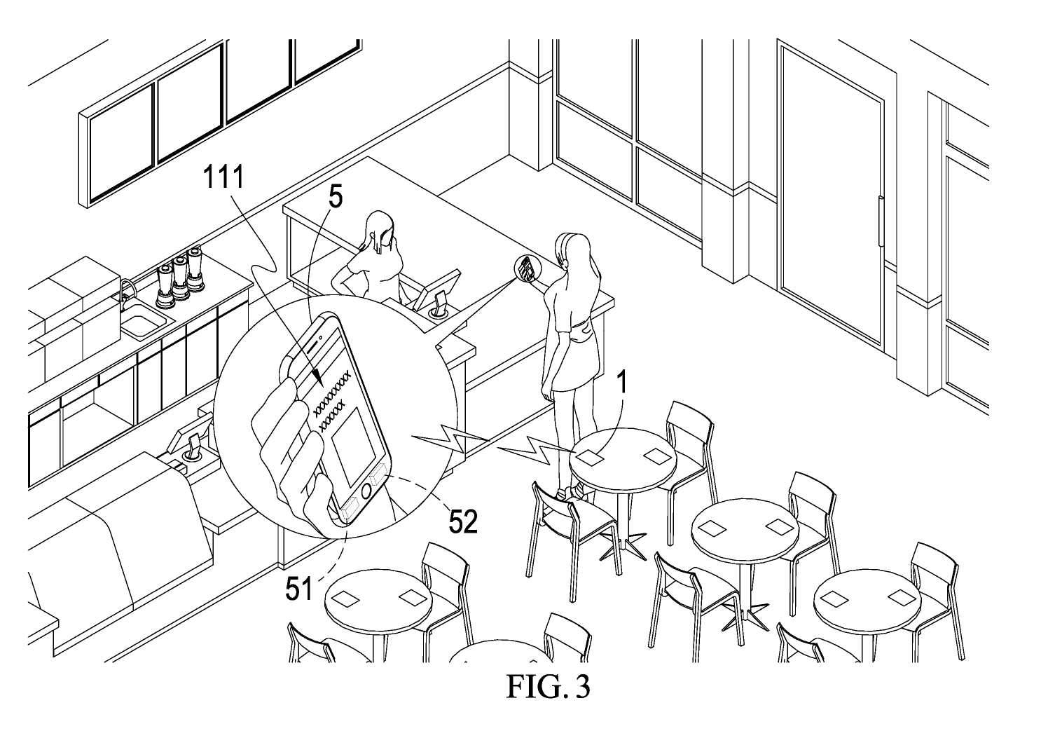

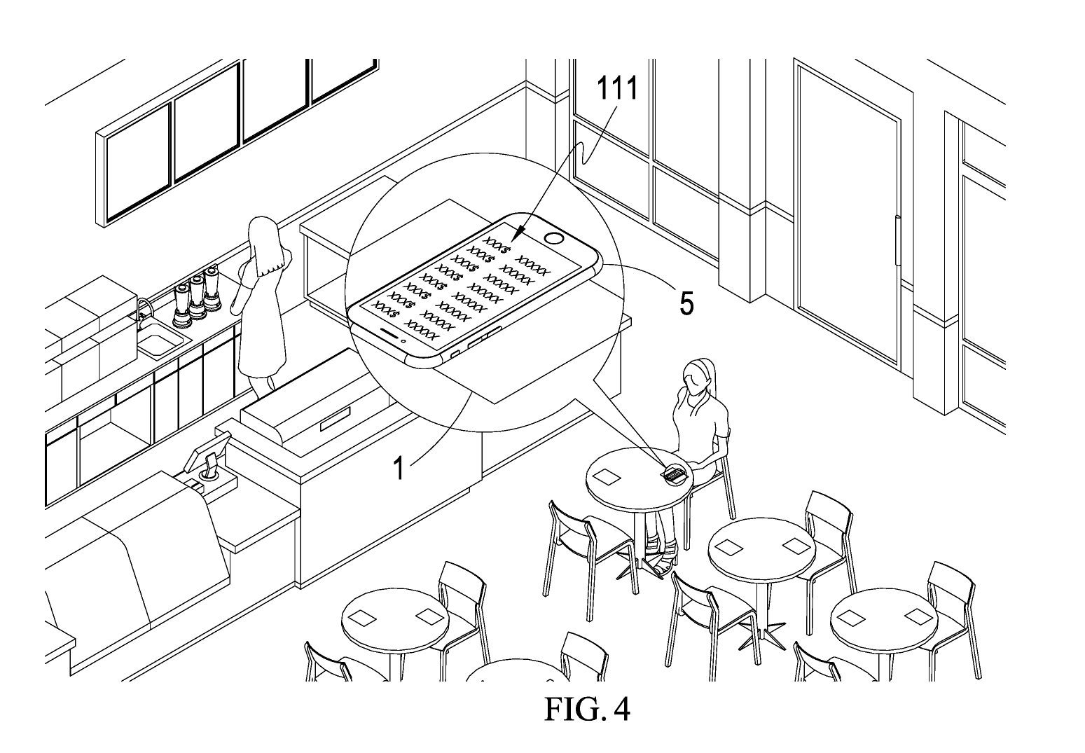

As shown in FIGS. 3 and 4, a first application scenario of the present embodiment involves the wireless charging device 1 installed in a restaurant/cafeteria, and a mobile device 5 having a built-in wireless charging Power Receiver Unit (PRU) 51 and data transceiver module 52. The wireless charging PRU 51 is linked with the wireless charging module 12. The detection module 13 is capable of Bluetooth-based communication. The data transceiver module 11 of the wireless charging device 1 provides a signal coverage. When the mobile device 5 enters the restaurant/cafeteria within the signal coverage, the data transceiver module 52 receives an info message 111 from the wireless charging device 1 which may be a web page describing features of the restaurant/cafeteria. The content of the info message 111 then may be presented on a screen of the mobile device 5. If the mobile device 5 is placed on the wireless charging device 1 for charging and the Bluetooth control element 123 detects the proximity of the mobile device 5, the power control element 122 activates the wireless charging module 12 to charge the mobile device 5 through its wireless charging PRU 51. While the mobile device 5 is charged, a different info message 111 is retrieved from the memory module 4 which contains the store's menu is delivered to the mobile device 5. As such, depending on the mobile device 5's location and usage, different info messages 111 may be provided accordingly.

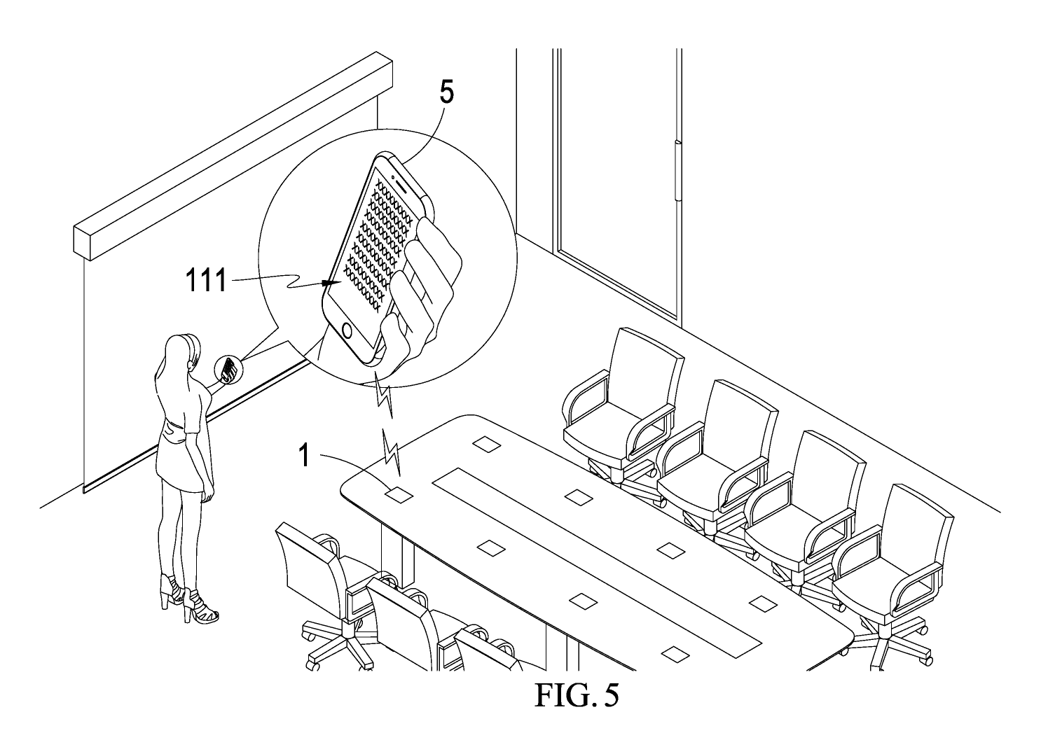

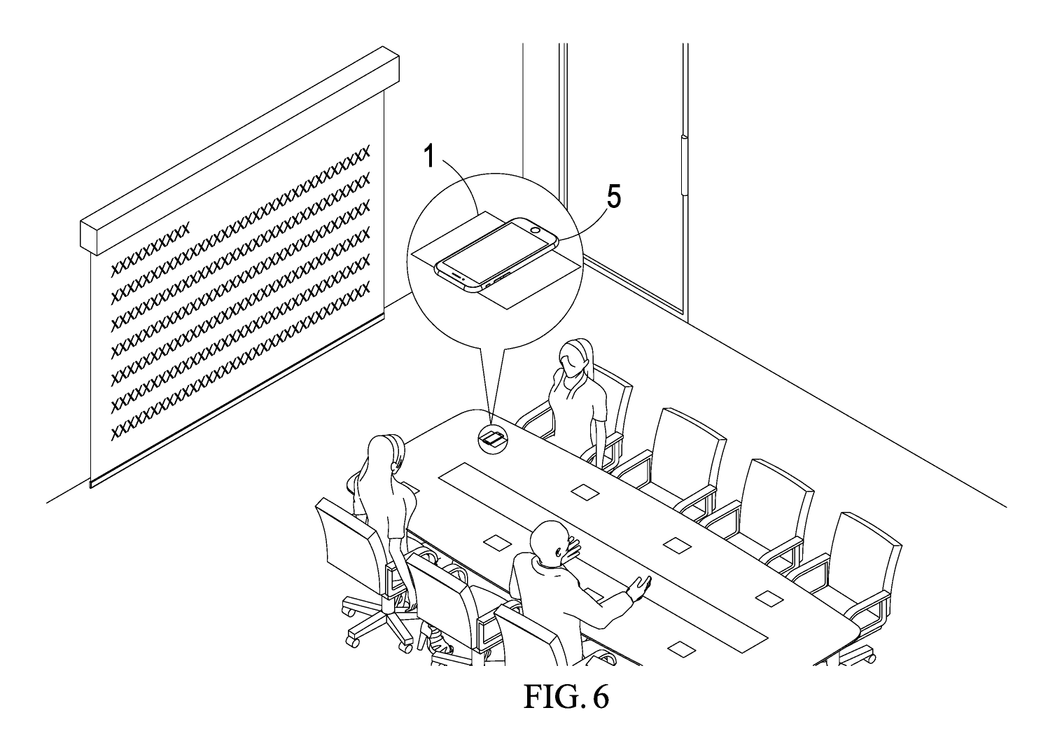

As shown in FIGS. 5 and 6, a second application scenario of the present embodiment involves the wireless charging device 1 installed in a conference room. When the mobile device 5 enters the conference room within the signal coverage, the data transceiver module 52 receives an info message 111 from the wireless charging device 1 which may include instruction about downloading and using an APP. The content of the info message 111 then may be presented on a screen of the mobile device 5. If the mobile device 5 is placed on the wireless charging device 1 for charging and the Bluetooth control element 123 detects the proximity of the mobile device 5, the power control element 122 activates the wireless charging module 12 to charge the mobile device 5 through its wireless charging PRU 51. While the mobile device 5 is charged, a different info message 111 is retrieved from the memory module 4 and delivered to the mobile device 5, which contains instruction about turning on the video mirroring function of the mobile device 5 so that the screen of the mobile device 5 is mirrored onto a projector of the conference room. As such, depending on the mobile device 5's location and usage, different info messages 111 may be provided accordingly.

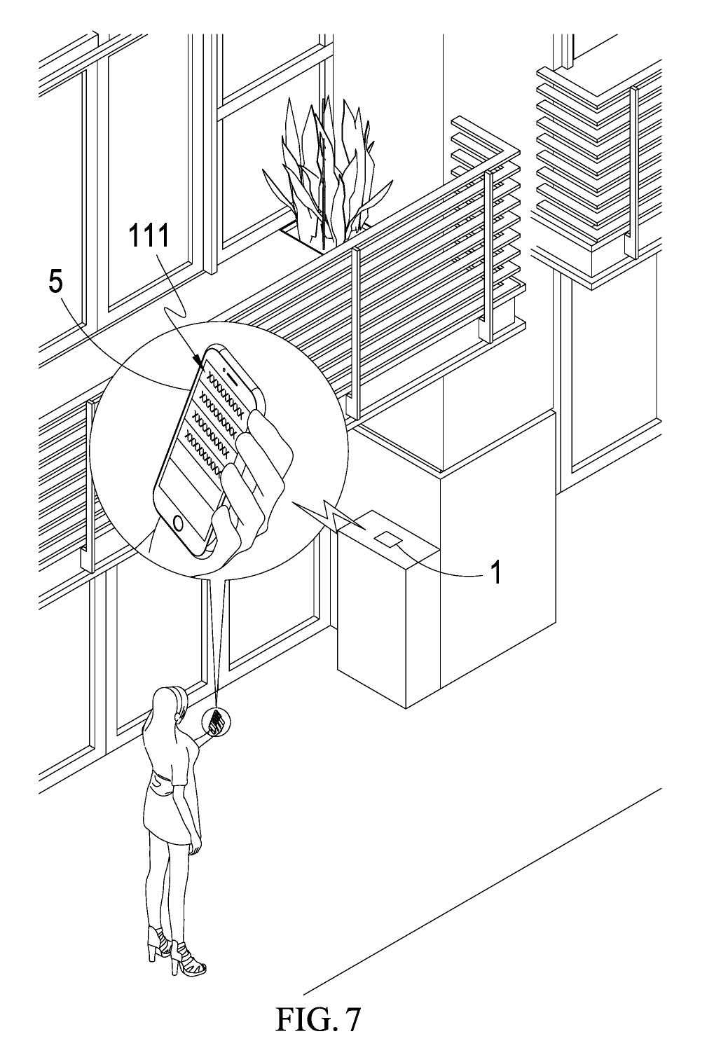

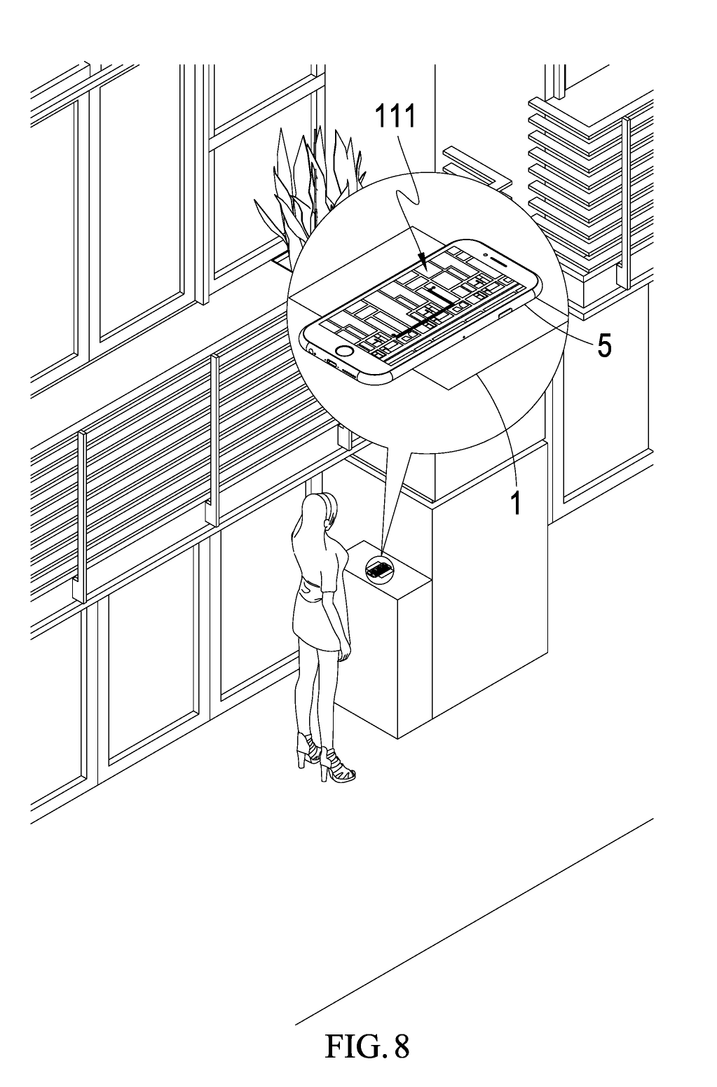

As shown in FIGS. 7 and 8, a third application scenario of the present embodiment involves the wireless charging device 1 installed in an outdoor environment. When the mobile device 5 is near the wireless charging device 1 within the signal coverage, the data transceiver module 52 receives an info message 111 from the wireless charging device 1 which may include information about near-by stores such as their web sites. The content of the info message 111 then may be presented on a screen of the mobile device 5. If the mobile device 5 is placed on the wireless charging device 1 for charging and the Bluetooth control element 123 detects the proximity of the mobile device 5, the power control element 122 activates the wireless charging module 12 to charge the mobile device 5 through its wireless charging PRU 51. While the mobile device 5 is charged, a different info message 111 is retrieved from the memory module 4 and delivered to the mobile device 5, which contains a surrounding map and navigation routes to the various stores. As such, depending on the mobile device 5's location and usage, different info messages 111 may be provided accordingly.

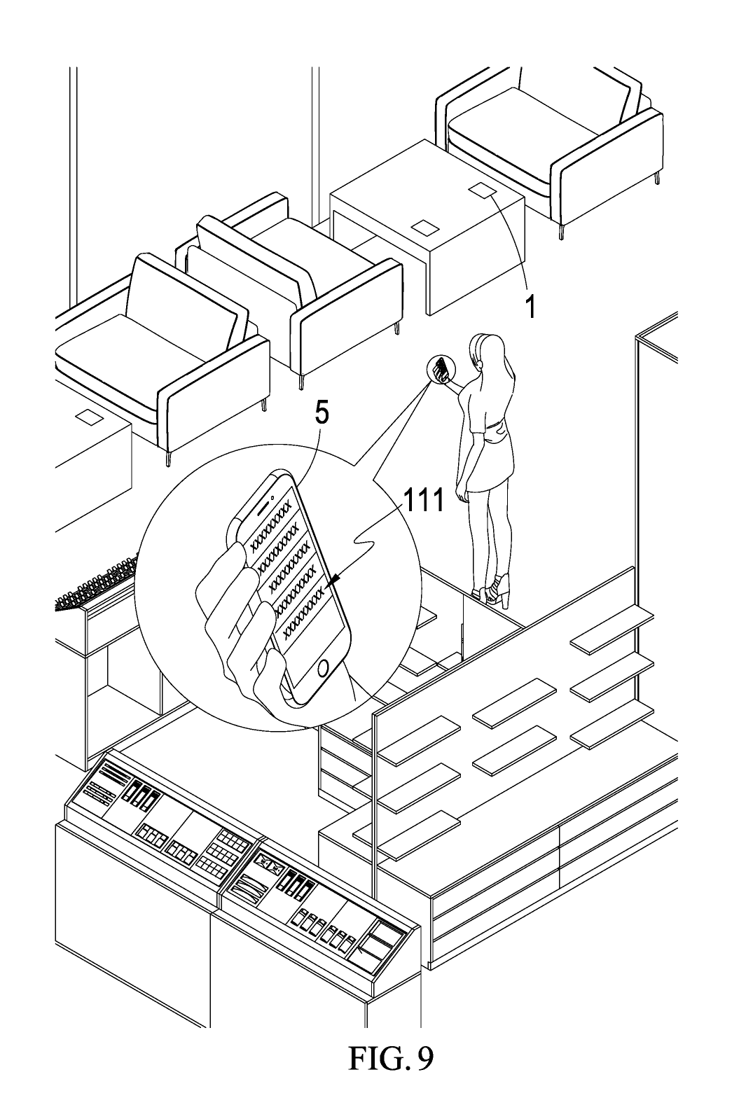

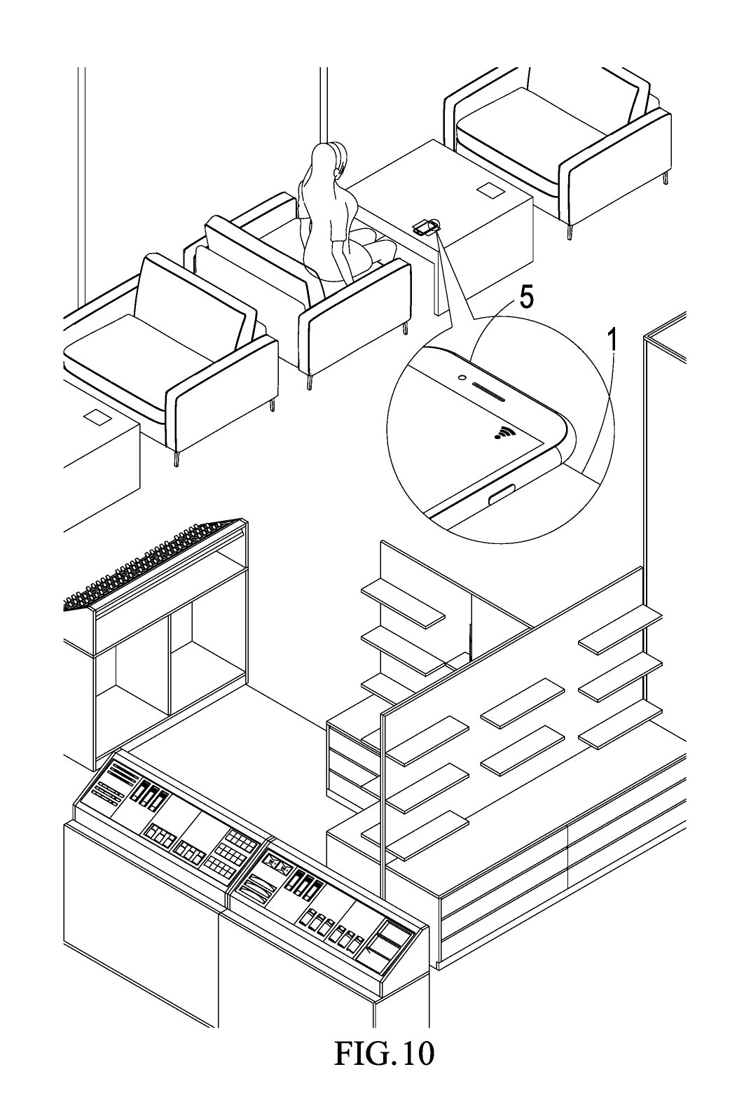

As shown in FIGS. 9 and 10, a fourth application scenario of the present embodiment involves the wireless charging device 1 installed in a department store. When the mobile device 5 is near the wireless charging device 1 within the signal coverage, the data transceiver module 52 receives an info message 111 from the wireless charging device 1 which may include information about near-by counters and the latest news about the department store. The content of the info message 111 then may be presented on a screen of the mobile device 5. If the mobile device 5 is placed on the wireless charging device 1 for charging and the Bluetooth control element 123 detects the proximity of the mobile device 5, the power control element 122 activates the wireless charging module 12 to charge the mobile device 5 through its wireless charging PRU 51. While the mobile device 5 is charged, a different info message 111 is retrieved from the memory module 4 and delivered to the mobile device 5, which contains instruction about how to connect to the department store's WIFI network so that the mobile device 5 may connect to the Internet while being charged. As such, depending on the mobile device 5's location and usage, different info messages 111 may be provided accordingly.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A wireless charging service system, comprising
a wireless charging device comprising a data transceiver module, a wireless charging module, and a detection module, where the data transceiver module is capable of transmitting one of a plurality of info messages, the wireless charging module operates in accordance with the result of an authentication process with a mobile device, the detection module detects whether the mobile device is placed on the wireless charging device and, depending on the detection result, triggers the data transceiver module to transmit an info message to the mobile device;
a server device data-linked with the data transceiver module of the wireless charging device; and
a remote cloud service data-linked with the server device where the info messages are prepared by the remote cloud service and relayed to the wireless charging device through the server device's data link with the data transceiver module.

2. The wireless charging service system according to claim 1, wherein the data transceiver module comprises a micro-location signal transmitter based on Bluetooth (beacon).

3. The wireless charging service system according to claim 1, wherein each info message includes one of information about an APP, a web page, a map, information about stores, and news.

4. The wireless charging service system according to claim 1, wherein the wireless charging module comprises a Power Transfer Unit (PTU) capable of wireless power transfer utilizing magnetic resonance.

5. The wireless charging service system according to claim 4, wherein the mobile device comprises a wireless charging Power Receiver Unit (PRU) wirelessly linked with the wireless charging module.

6. The wireless charging service system according to claim 5, wherein the mobile device comprises a data transceiver module for receiving info message from the wireless charging device.

7. The wireless charging service system according to claim 1, wherein the wireless charging module comprises a rectifier element receiving external power, a power control element electrically connected to the rectifier element, a Bluetooth control element electrically connected to the rectifier and power control elements; and the data transceiver module is electrically connected to the power control element.

8. The wireless charging service system according to claim 1, further comprising a memory module which stores at least one of the info messages prepared by the remote cloud service.
